(19) United States
(12) Patent Application Publication
(10) Pub. No.: US 2012/0053287 A1
(43) Pub. Date: Mar. 1, 2012

(54) RESIN COMPOSITION FOR INSULATING LAYER

(75) Inventor: Isao Yahagi, Ibaraki (JP)

(73) Assignee: Sumitomo Chemical Company, Ltd, Chuo-ku, Tokyo (JP)

(21) Appl. No.: 13/144,237

(22) PCT Filed: Jan. 7, 2010
(86) PCT No.: PCT/JP2010/050082

§ 371 Date: Sep. 29, 2011

(30) Foreign Application Priority Data
Jan. 14, 2009 (JP) 2009-005812

(51) Int. Cl. C08L 35/02; C08L 35/08; C08L 41/00

(52) U.S. Cl. 524/545; 524/544; 524/555; 524/547

(57) ABSTRACT

The problem to be solved is to provide a resin composition for an organic thin film transistor insulating layer which can cross-link without being subjected to a treatment at a high temperature for a long time to form an insulating layer excellent in surface adhesion property. The solving means is a resin composition for an organic thin film transistor insulating layer comprising (A) a macromolecular compound comprising a repeating unit having a photosensitive group s linked through a urea bond or a urethane bond, (B) a curing agent and (C) an organic solvent.

### TECHNICAL FIELD

The present invention relates to a resin composition for forming an insulating layer, and particularly to a resin composition for forming an insulating layer in an organic thin film transistor.

### BACKGROUND ART

Since organic field effect transistors can be produced by a lower temperature process than inorganic semiconductors, a plastic substrate and a film can be used as a substrate, and devices that are lightweight and that do not easily break can be produced. Moreover, in some cases, devices can be produced by film formation using a method of applying or printing a solution containing organic materials, so that devices having large area can be produced at low cost. Furthermore, since there are a wide variety of materials which can be used for investigation of transistors, material properties can easily be changed thoroughly with the materials different in molecular structure being used for the investigation. Therefore, it is also possible to realize flexible functions, devices and the like, which are impossible with inorganic semiconductors by combining the materials each having different functions.

In field effect transistors, the voltage applied to a gate electrode acts on a semiconductor layer through a gate insulating layer, and controls on and off of the drain current. For this purpose, a gate insulating layer is formed between the gate electrode and the semiconductor layer.

Organic semiconductor compounds to be used for organic field effect transistors are vulnerable to environmental factors such as humidity and oxygen, and therefore transistor characteristics tend to have deterioration with time caused by humidity, oxygen and the like.

Therefore, in a bottom gated type organic field effect transistor device structure with an organic semiconductor compound uncovered, it is essential to protect the organic semiconductor compound from its contact with the external atmosphere by forming an overcoat layer that wholly covers the device structure. In a top gated type organic field effect transistor device structure, on the other hand, an organic semiconductor compound is coated with a gate insulating layer, thereby being protected.

Thus, in organic field effect transistors, a resin composition is used in order to form an overcoat layer, a gate insulating layer or the like to cover organic semiconductor layers. A resin composition to be used for forming such an insulating layer and an insulating film is referred to herein as a resin composition for insulating layer.

Resin compositions for insulating layers are required to have such characteristics as strength to insulation breakage when having been formed into thin film, affinity with an organic semiconductor for forming good interface with the organic semiconductor, and flatness of a film surface which forms an interface with a semiconductor. If a macromolecular compound contained in an insulating layer has been cross-linked, electrical properties becomes good. However, if a resin composition for an insulating layer is treated at a high temperature for a long time for cross-linking, the organic substances which constitute a device will be degraded, leading to drop in transistor characteristics. Therefore, it is preferable to cross-link the resin composition for an insulating layer at relatively low temperatures.

For example, Patent Document 1 describes a layer containing fluororesin as a gate insulating layer in an organic field effect transistor. However, it is difficult to form a flat layer by a coating method on the organic field effect transistor in which the fluororesin has been used in its insulating layer due to problems with respect to liquid repellency and adhesion property of the fluororesin, and it is also difficult to make an electrode or the like adhere stably to the surface of the insulating layer.

Therefore, there has been desired such a resin composition for an organic thin film transistor insulating layer that, when being used for an organic field effect transistor, it is excellent in electrically insulating property, it can form easily a layered structure of organic layers including an insulating layer without adversely influencing transistor characteristics, and the insulating layer being excellent in surface adhesion property.

### BACKGROUND ART DOCUMENT

### Patent Document

Patent Document 1: Japanese Patent Laid-open Publication No. 2005-513788

### DISCLOSURE OF THE INVENTION

### Problems to be Solved by the Invention

The present invention solves the above-described conventional problems and an objective thereof is to provide a resin composition for an organic thin film transistor insulating layer which can form an insulating layer with excellent surface adhesiveness without being subjected to a treatment at a high temperature for a long time.

### Means for Solving the Problems

As a result of various studies in view of the above-described problems, the present invention has been accomplished by finding that the above problems can be solved by the use of a specific photosensitive resin composition.

In other words, firstly, the present invention provides a resin composition for an organic thin film transistor insulating layer characterized by comprising (A) a macromolecular compound comprising a repeating unit having a photosensitive group linked through a urea bond or a urethane bond, (B) a curing agent and (C) an organic solvent.

Secondly, the present invention provides the resin composition for an organic thin film transistor insulating layer according to claim 1, characterized by that the macromolecular compound comprising a repeating unit having a photosensitive group linked through a urea bond or a urethane bond is a macromolecular compound comprising at least one kind of repeating unit selected from the group consisting of repeating units represented by formula (1) and repeating units represented by formula (2):

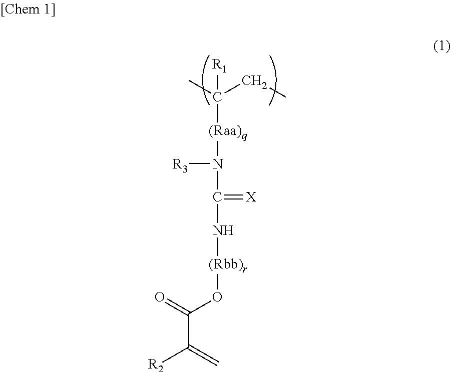

wherein R₁ and R₂, which are the same or different, each represents a hydrogen atom or a methyl group, R₃ represents a monovalent organic group having 1 to 20 carbon atoms, and Raa and Rbb, which are the same or different, each represents a divalent organic group having 1 to 20 carbon atoms; any hydrogen atom in the divalent organic group may be substituted with a fluorine atom; X represents an oxygen atom or a sulfur atom, q represents an integer of 0 to 20, and r represents an integer of 1 to 20; when there are two or more Raa's, they may be the same or different; and when there are two or more Rbb's, they may be the same or different;

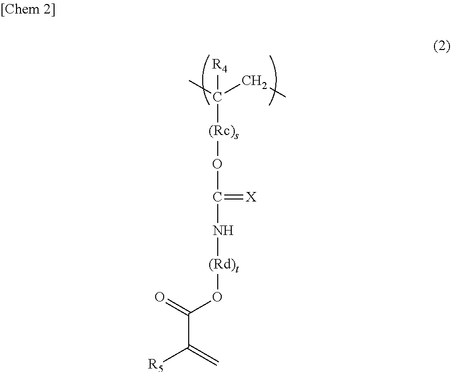

wherein R₄ and R₅, which are the same or different, each represents a hydrogen atom or a methyl group, and Re and Rd, which are the same or different, each represents a divalent organic group having 1 to 20 carbon atoms; any hydrogen atom in the divalent organic group may be substituted with a fluorine atom; X represents an oxygen atom or a sulfur atom, s represents an integer of 0 to 20, and t represents an integer of 1 to 20; when there are two or more Rc's, they may be the same or different, and when there are two or more Rd's, they may be the same or different.

Thirdly, the present invention provides the aforementioned resin composition for an organic thin film transistor insulating layer, characterized by that the macromolecular compound further includes at least one kind of repeating unit selected from the group consisting of repeating units represented by formula (3), repeating units represented by formula (4), repeating units represented by formula (5), and repeating units represented by formula (6):

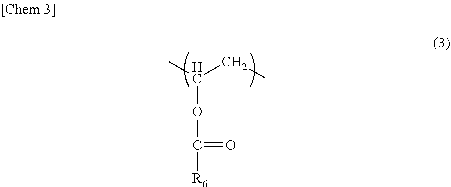

wherein R₆ represents a monovalent organic group having 1 to 20 carbon atoms, and any hydrogen atom in the monovalent organic group may be substituted with a fluorine atom;

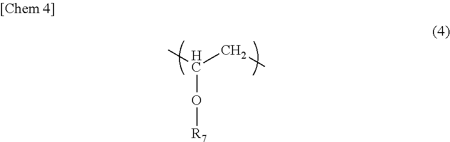

wherein R₇ represents a monovalent organic group having 1 to 20 carbon atoms, and any hydrogen atom in the monovalent organic group may be substituted with a fluorine atom;

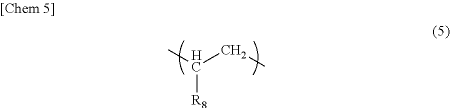

wherein R₈ represents a monovalent organic group having 1 to 20 carbon atoms or a cyano group, and any hydrogen atom in the monovalent organic group may be substituted with a fluorine atom;

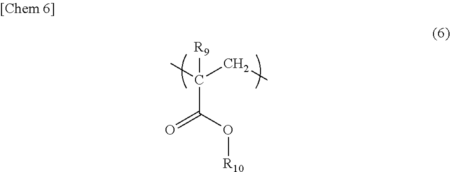

wherein R₉ represents a hydrogen atom or a methyl group, R₁₀ represents a monovalent organic group having 1 to 20 carbon atoms, and any hydrogen atom in the divalent organic group may be substituted with a fluorine atom.

Fourthly, the present invention provides an organic thin film transistor characterized by using the aforementioned resin composition for an organic thin film transistor insulating layer as an overcoat layer.

Fifthly, the present invention provides an organic thin film transistor characterized by using the aforementioned resin composition for an organic thin film transistor insulating layer as a gate insulating layer.

Sixthly, the present invention provides a member for a display comprising the aforementioned resin composition for an organic thin film transistor insulating layer.

Seventhly, the present invention provides a display composed of the aforementioned member for a display.

### Effect of the Invention

The resin composition for an insulating layer of the present invention can form a cross-linked structure and is excellent in electrical properties. In addition, since it is photosensitive and there is no necessity to heat it at a high temperature for a long time when forming the cross-linked structure, adverse influence is not exerted on transistor characteristics. Moreover, since the insulating layer to be formed therefrom is excellent in adhesiveness at its surface, it is possible to easily form a layered structure of organic layers including the insulating layer.

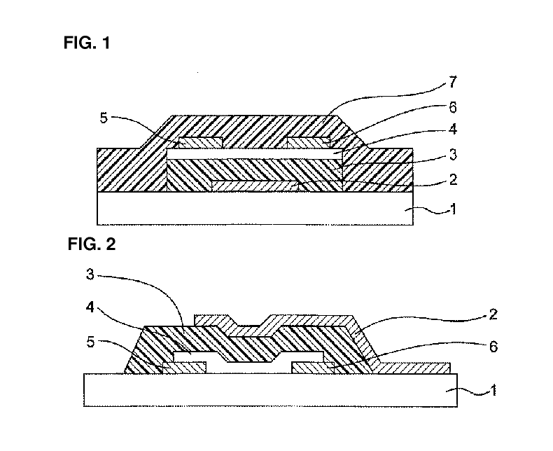

### BRIEF DESCRIPTION OF THE DRAWINGS

[FIG. 1] A schematic cross-sectional view illustrating the structure of a bottom gate type organic thin film transistor, which is one embodiment of the present invention.

[FIG. 2] A schematic cross-sectional view illustrating the structure of a top gate type organic thin film transistor, which is one embodiment of the present invention.

### EMBODIMENT FOR CARRYING OUT THE INVENTION

The present invention is described in more detail below. In this description, a “macromolecular compound” refers to any compound comprising a structure in which two or more identical structural units are repeated in a molecule, and this includes a so-called dimer. On the other hand, a “low-molecular compound” means any compound that does not have identical structural units repeatedly in a molecule.

The resin composition for an organic thin film transistor insulating layer of the present invention is characterized by comprising (A) a macromolecular compound comprising a repeating unit having a photosensitive group linked through a urea bond or a urethane bond, (B) a curing agent and (C) an organic solvent.

Macromolecular Compound (A)

The macromolecular compound to be used for the present invention comprises a repeating unit having a photosensitive group linked through a urea bond or a urethane bond. The term “photosensitive group” means a group capable of being chemically changed through irradiation with light or radiation and specifically represents a group having a structure represented by the following formula:

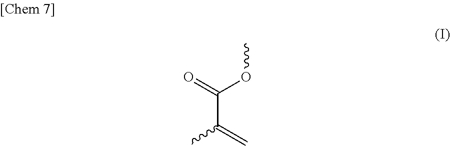

wherein the wavy line represents a bond.

The macromolecular compound is preferably a macromolecular compound comprising at least one kind of repeating unit selected from the group consisting of repeating units represented by formula (1) and repeating units represented by formula (2).

In the macromolecular compound to be used for the present invention, any of the repeating units represented by formulae (1) to (6) preferably includes fluorine atom. This is because if there is a fluorine atom in the resin structure, electrical properties such as insulating property, of a layer to be formed are improved. The fluorine atom is preferably present as a substituent of an organic group at a side chain part of the repeating unit. This makes the layer to be formed hardly deteriorate in surface adhesiveness in comparison with the case that a fluorine atom substitutes at a main chain part.

The amount of fluorine to be introduced to the macromolecular compound (A) is preferably not more than 60% by weight, more preferably 5 to 50% by weight, and even more preferably 5 to 40% by weight based on the weight of the macromolecular compound. If the amount of fluorine exceeds 60% by weight, the surface adhesiveness of a layer to be formed tends to deteriorate.

In formula (1) and formula (2), R₁, R₂, R₄ and R₅, which are the same or different, each represents a hydrogen atom or a methyl group, and R₃ represents a hydrogen atom or a monovalent organic group having 1 to 20 carbon atoms. In one embodiment, R₁ and R₄ are hydrogen atoms, R2 and R₅ are methyl groups, and R₃ is a hydrogen atom. Raa, Rbb, Rc and Rd, which are the same or different, each represents a divalent organic group having 1 to 20 carbon atoms. Any hydrogen atom in the divalent organic group may be substituted with a fluorine atom. X represents an oxygen atom or a sulfur atom, q and s each represents an integer of 0 to 20, and r and t each represents an integer of 1 to 20. When there are two or more Raa's, they may be the same or different. When there are two or more Rbb's, they may be the same or different. When there are two or more Rc's, they may be the same or different. When there are two or more Rd's, they may be the same or different. In one embodiment, X is an oxygen atom and q, r, s and t are 1.

The divalent organic group having 1 to 20 carbon atoms may be linear, branched or cyclic. Examples thereof include linear aliphatic hydrocarbon groups having 1 to 20 carbon atoms, branched aliphatic hydrocarbon groups having 3 to 20 carbon atoms, alicyclic hydrocarbon groups having 3 to 20 carbon atoms, and aromatic hydrocarbon groups having 6 to 20 carbon atoms that may be substituted with an alkyl group or the like, and preferred are linear hydrocarbon groups having 1 to 6 carbon atoms, branched hydrocarbon groups having 3 to 6 carbon atoms, cyclic hydrocarbon groups having 3 to 6 carbon atoms and aromatic hydrocarbon groups having 6 to 20 carbon atoms that may be substituted with an alkyl group or the like.

Specific examples of the aliphatic hydrocarbon groups include a methylene group, an ethylene group, a propylene group, a butylene group, a pentylene group, a hexylene group, an isopropylene group, an isobutylene group, a dimethylpropylene group, a cyclopropylene group, a cyclobutylene group, a cyclopentylene group and a cyclohexylene group.

Specific examples of the divalent aromatic hydrocarbon groups having 6 to 20 carbon atoms include a phenylene group, a naphthylene group, an anthrylene group, a dimethylphenylene group, a trimethylphenylene group, an ethylenephenylene group, a diethylenephenylene group, a triethylenephenylene group, a propylenephenylene group, a butylenephenylene group, a methylnaphthylene group, a dimethylnaphthylene group, a trimethylnaphthylene group, a vinylnaphthylene group, an ethenylenenaphthylene group, a methylanthrylene group and an ethylanthrylene group.

In one embodiment, Raa and Rc are phenylene groups. Rbb and Rd are ethylene groups.

The monovalent organic group having 1 to 20 carbon atoms may be linear, branched, or cyclic and also may be saturated or unsaturated.

Examples of the monovalent organic group having 1 to 20 carbon atoms include linear hydrocarbon groups having 1 to 20 carbon atoms, branched hydrocarbon groups having 3 to 20 carbon atoms, cyclic hydrocarbon groups having 3 to 20 carbon atoms and aromatic hydrocarbon groups having 6 to 20 carbon atoms, and preferred are linear hydrocarbon groups having 1 to 6 carbon atoms, branched hydrocarbon groups having 3 to 6 carbon atoms, cyclic hydrocarbon groups having 3 to 6 carbon atoms and aromatic hydrocarbon groups having 6 to 20 carbon atoms.

As to the linear hydrocarbon groups having 1 to 20 carbon atoms, the branched hydrocarbon groups having 3 to 20 carbon atoms and the cyclic hydrocarbon groups having 3 to 20 carbon atoms, any hydrogen atom contained in these groups may be substituted with a fluorine atom.

As to the aromatic hydrocarbon groups having 6 to 20 carbon atoms, any hydrogen atom in the groups may be substituted with an alkyl group, a fluoroalkyl group, a halogen atom or the like.

Specific examples of the monovalent organic group having 1 to 20 carbon atoms include a methyl group, an ethyl group, a propyl group, a butyl group, a pentyl group, a hexyl group, an isopropyl group, an isobutyl group, a tertiary butyl group, a cyclopropyl group, a cyclobutyl group, a cyclopentyl group, a cyclohexyl group, a cyclopentynyl group, a cyclohexynyl group, a trifluoromethyl group, a trifluoroethyl group, a phenyl group, a naphthyl group, an anthryl group, a tolyl group, a xylyl group, a dimethylphenyl group, a trimethylphenyl group, an ethylphenyl group, a diethylphenyl group, a triethylphenyl group, a propylphenyl group, a butylphenyl group, a methylnaphthyl group, a dimethylnaphthyl group, a trimethylnaphthyl group, a vinylnaphthyl group, a methylanthryl group, an ethylanthryl group, a chlorophenyl group and a bromophenyl group.

An alkyl group is preferred as the monovalent organic group having 1 to 20 carbon atoms.

The macromolecular compound to be used for the present invention may further include at least one kind of repeating unit selected from the group consisting of repeating units represented by formula (3), repeating units represented by formula (4), repeating units represented by formula (5) and repeating units represented by formula (6).

In formula (3) through formula (6), R₆, R₇ and R₁₀, which are the same or different, each represents a monovalent organic group having 1 to 20 carbon atoms. Any hydrogen atom in the monovalent organic group may be substituted with a fluorine atom. R₈ represents a monovalent organic group having 1 to 20 carbon atoms or a cyano group. Any hydrogen atom in the monovalent organic group may be substituted with a fluorine atom. R₉ represents a hydrogen atom or a methyl group. Specific examples of the monovalent organic group having 1 to 20 carbon atoms are the same as those having already been explained.

In one embodiment, any of R₆ and R₈ is a group selected from the group consisting of a phenyl group, an o-fluoroalkylphenyl group and a p-fluoroalkylphenyl group. Preferably, any of R₆ and R₈ is a group selected from the group consisting of a phenyl group and an o-fluoroalkylphenyl group. One preferable example of the o-fluoroalkylphenyl group is an o-trifluoromethylphenyl group. One preferable example of the p-fluoroalkylphenyl group is a p-trifluoromethylphenyl group.

The macromolecular compound to be used for the present invention can be produced by a method that comprises polymerizing a polymerizable monomer that has an active hydrogen-containing group and serves as a raw material of the repeating unit represented by formula (1) and formula (2) by using a photopolymerization initiator or a thermal polymerization initiator, and then letting the resultant to react with an acrylate compound having an isocyanato group or an isothiocyanato group in a molecule thereof, or a methacrylate compound having an isocyanato group or an isothiocyanato group in a molecule thereof.

When the macromolecular compound to be used for the present invention has at least one kind of repeating unit selected from the group consisting of repeating units represented by formula (3), repeating units represented by formula (4), repeating units represented by formula (5) and repeating units represented by formula (6), it can be produced also by a method that comprises copolymerizing a polymerizable monomer that has an active hydrogen-containing group and serves as a raw material of repeating units represented by formula (1) and formula (2) with a polymerizable monomer that serves as a raw material of repeating units represented by formula (3) through formula (6) by using a photopolymerization initiator or a thermal polymerization initiator, and then letting the resultant to react with an acrylate compound having an isocyanato group or an isothiocyanato group in a molecule thereof, or a methacrylate compound having an isocyanato group or an isothiocyanato group in a molecule thereof.

Examples of the polymerizable monomer that has an active hydrogen-containing group and serves as a raw material of the repeating unit represented by formula (1) and formula (2) include 4-aminostyrene, 4-allylaniline, 4-aminophenyl vinyl ether, 4-(N-phenylamino)phenyl allyl ether, 4-(N-methylamino)phenyl allyl ether, 4-aminophenyl allyl ether, allylamine, 2-aminoethyl acrylate, 4-hydroxystyrene, 4-hydroxyallylbenzene, 4-hydroxyphenyl vinyl ether, 4-hydroxyphenyl allyl ether, 4-hydroxybutyl vinyl ether, vinyl alcohol, 2-hydroxyethyl acrylate, 2-hydroxypropyl acrylate, 3-hydroxypropyl acrylate, 2-hydroxybutyl acrylate, 4-hydroxyphenyl acrylate, 2-hydroxyphenylethyl acrylate 2-aminoethyl methacrylate, 2-hydroxyethyl methacrylate, 2-hydroxypropyl methacrylate, 3-hydroxypropyl methacrylate, 2-hydroxybutyl methacrylate, 4-hydroxyphenyl methacrylate and 2-hydroxyphenylethyl methacrylate.

Examples of the acrylate compound having an isocyanato group or an isothiocyanato group in a molecule thereof include 2-acryloyloxyethyl isocyanate and 2-acryloyloxyethyl isothiocyanate.

Examples of the methacrylate compound having an isocyanato group or an isothiocyanato group in a molecule thereof include 2-methacryloyloxyethyl isocyanate, 2-(2′-methacryloyloxyethyl)oxyethyl isocyanate, 2-methacryloyloxyethyl isothiocyanate and 2-(2′-methacryloyloxy-ethyl)oxyethyl isothiocyanate.

Examples of the polymerizable monomer to be used as a raw material of the repeating unit represented by formula (3) include vinylacetic acid, vinyl propionate, vinyl butyrate, vinyl benzoate, vinyl-2-methyl benzoate, vinyl-3-methyl benzoate, vinyl-4-methyl benzoate, vinyl-2-trifluoromethyl benzoate, vinyl-3-trifluoromethyl benzoate and vinyl-4-trifluoromethyl benzoate.

Examples of the polymerizable monomer to be used as a raw material of the repeating unit represented by formula (4) include vinyl methyl ether, vinyl ethyl ether, vinyl propyl ether, vinyl butyl ether, vinyl phenyl ether, vinyl benzyl ether, vinyl 4-methylphenyl ether and vinyl 4-trifluoromethylphenyl ether.

Examples of the polymerizable monomer to be used as a raw material of the repeating unit represented by formula (5) include styrene, α-methylstyrene, 2,4-dimethyl-α-methylstyrene, o-methylstyrene, m-methylstyrene, p-methylstyrene, 2,4-dimethylstyrene, 2,5-dimethylstyrene, 2,6-dimethylstyrene, 3,4-dimethylstyrene, 3,5-dimethylstyrene, 2,4,6-trimethylstyrene, 2,4,5-trimethylstyrene, pentamethylstyrene, o-ethylstyrene, m-ethylstyrene, p-ethylstyrene, o-chlorostyrene, m-chlorostyrene, p-chlorostyrene, o-bromostyrene, m-bromostyrene, p-bromostyrene, o-methoxystyrene, m-methoxystyrene, p-methoxystyrene, o-hydroxystyrene, m-hydroxystyrene, p-hydroxystyrene, 2-vinylbiphenyl, 3-vinylbiphenyl, 4-vinylbiphenyl, 1-vinylnaphthalene, 2-vinylnaphthalene, 4-vinyl-p-terphenyl, 1-vinylanthracene, o-isopropenyltoluene, m-isopropenyltoluene, p-isopropenyltoluene, 2,4-dimethyl-α-methylstyrene, 2,3-dimethyl-α-methylstyrene, 3,5-dimethyl-α-methylstyrene, p-isopropyl-α-methylstyrene, α-ethylstyrene, α-chlorostyrene, divinylbenzene, divinylbiphenyl, diisopropylbenzene, 4-aminostyrene, 2,3,4,5,6-pentafluorostyrene, 2-trifluoromethylstyrene, 3-trifluoromethylstyrene, 4-trifluoromethylstyrene, acrylonitrile, allyl acetate, allyl benzoate, N-methyl-N-vinylacetamide, 1-butene, 1-pentene, 1-hexene, 1-octene, vinylcyclohexane, vinyl chloride, allyltrimethylgermanium, allyltriethylgermanium, allyltributylgermanium, trimethylvinylgermanium and triethylvinylgermanium.

Examples of the polymerizable monomer to be used as a raw material of the repeating unit represented by formula (6) include methyl acrylate, ethyl acrylate, n-propyl acrylate, isopropyl acrylate, n-butyl acrylate, isobutyl acrylate, sec-butyl acrylate, hexyl acrylate, octyl acrylate, 2-ethylhexyl acrylate, decyl acrylate, isobornyl acrylate, cyclohexyl acrylate, phenyl acrylate, benzil acrylate, N,N-dimethylacrylamide, N,N-diethylacrylamide, methyl methacrylate, ethyl methacrylate, n-propyl methacrylate, isopropyl methacrylate, n-butyl methacrylate, isobutyl methacrylate, sec-butyl methacrylate, hexyl methacrylate, octyl methacrylate, 2-ethylhexyl methacrylate, decyl methacrylate, isobornyl methacrylate, cyclohexyl methacrylate, phenyl methacrylate, benzyl methacrylate, N,N-dimethylmethacrylamide, N,N-diethylmethacrylamide, N-acryloylmorpholine, 2,2,2-trifluoroethyl acrylate, 2,2,3,3,3-pentafluoropropyl acrylate, 2-(perfluorobutypethyl acrylate, 3-perfluorobutyl-2-hydroxypropyl acrylate, 2-(perfluorohexypethyl acrylate, 3-perfluorohexyl-2-hydroxypropyl acrylate, 2-(perfluorooctyl)ethyl acrylate, 3-perfluorooctyl-2-hydroxypropyl acrylate, 2-(perfluorodecyl)ethyl acrylate, 2-(perfluoro-3-methylbutyl)ethyl acrylate, 3-(perfluoro-3-methylbutyl)-2-hydroxypropyl acrylate, 2-(perfluoro-5-methylhexypethyl acrylate, 2-(perfluoro-3-methylbutyl)-2-hydroxypropyl acrylate, 3-(perfluoro-5-methylhexyl)-2-hydroxypropyl acrylate, 2-(perfluoro-7-methyloctyl)ethyl acrylate, 3-(perfluoro-7-methyloctyl)-2-hydroxypropyl acrylate, 1H,1H-3H-tetrafluoropropyl acrylate, 1H,1H-5H-octafluoropentyl acrylate, 1H-1H-7H-dodecafluoroheptyl acrylate, 1H,1H,9H-hexadecafluorononyl acrylate, 1H-1-(trifluoromethyl)trifluoroethyl acrylate, 1H,1H,3H-hexafluorobutyl acrylate, 2,2,2-trifluoroethyl methacrylate, 2,2,3,3,3-pentafluoropropyl methacrylate, 2-(perfluorobutyl)ethyl methacrylate, 3-perfluorobutyl-2-hydroxypropyl methacrylate, 2-(perfluorohexypethyl methacrylate, 3-perfluorohexyl-2-hydroxypropyl methacrylate, 2-(perfluorooctyl)ethyl methacrylate, 3-perfluorooctyl-2-hydroxypropyl methacrylate, 2-(perfluorodecynethyl methacrylate, 2-(perfluoro-3-methylbutyl)ethyl methacrylate, 3-(perfluoro-3-methylbutyl)-2-hydroxypropyl methacrylate, 2-(perfluoro-5-methylhexypethyl methacrylate, 2-(perfluoro-3-methylbutyl)-2-hydroxypropyl methacrylate, 3-(perfluoro-5-methylhexyl)-2-hydroxypropyl methacrylate, 2-(perfluoro-7-methyloctypethyl methacrylate, 3-(perfluoro-7-methyloctyl)-2-hydroxypropyl methacrylate, 1H,1H-3H-tetrafluoropropyl methacrylate, 1H,1H,5H-octafluoropentyl methacrylate, 1H,1H,7H-dodecafluoroheptyl methacrylate, 1H,1H,9H-hexadecafluorononyl methacrylate, 1H-1-(trifluoromethyl)trifluoroethyl methacrylate and 1H,1H,3H-hexafluorobutyl methacrylate.

Examples of the photopolymerization initiator include carbonyl compounds such as acetophenone, 2,2-dimethoxy-2-phenylacetophenone, 2,2-diethoxyacetophenone, 4-isopropyl-2-hydroxy-2-methylpropiophenone, 2-hydroxy-2-methylpropiophenone, 4,4′-bis(diethylamino)benzophenone, benzophenone, methyl(o-benzoyl) benzoate, 1-phenyl-1,2-propanedione-2-(o-ethoxycarbonyl)oxime, 1-phenyl-1,2-propanedione-2(o-benzoyl)oxime, benzoin, benzoin methyl ether, benzoin ethyl ether, benzoin isopropyl ether, benzoin isobutyl ether, benzoin octyl ether, benzil, benzyl dimethyl ketal, benzyl diethyl ketal and diacetyl, derivatives of anthraquinone or thioxanthone such as methylanthraquinone, chloro anthraquinone, chlorothioxanthone, 2-methylthioxanthone and 2- isopropylthioxanthone, and sulfur compounds such as diphenyldisulfide and dithiocarbamate.

The thermal polymerization initiator may be any substance that can serve as an initiator of radical polymerization, and examples thereof include azo type compounds such as 2,2′-azobisisobutyronitrile, 2,2′-azobisisovaleronitrile, 2,2′-azobis(2,4-dimethylvaleronitrile), 4,4′-azobis(4-cyanovaleric acid), 1,1′-azobis(cyclohexanecarbonitrile), 2,2′-azobis(2-methylpropane) and 2,2′azobis(2-methylpropionamidine) dihydrochloride, ketone peroxides such as methyl ethyl ketone peroxide, methyl isobutyl ketone peroxide, cyclohexanone peroxide and acetylacetone peroxide, diacyl peroxides such as isobutyl peroxide, benzoyl peroxide, 2,4-dichlorobenzoyl peroxide, o-methylbenzoyl peroxide, lauroyl peroxide and p-chlorobenzoyl peroxide, hydroperoxides such as 2,4,4-trimethylpentyl-2-hydroperoxide, diisopropylbenzene peroxide, cumene hydroperoxide and tert-butyl peroxide, dialkyl peroxides such as dicumyl peroxide, tert-butylcumyl peroxide, di-tert-butyl peroxide and tris(tert-butyl peroxy)triazine, peroxyketals such as 1,1-di-tert-butylperoxycyclohexane and 2,2-di(tert-butyl peroxy)butane, alkyl peroxyesters such as tert-butyl peroxypivalate, tert-butyl peroxy-2-ethylhexanoate, tert-butyl peroxyisobutylate, di-tert-butyl peroxyhexahydroterephthalate, di-tert-butyl peroxyazelate, tert-butyl peroxy-3,5,5-trimethylhaxonoate, tert-butyl peroxyacetate, tert-butyl peroxybenzoate and di-tert-butyl peroxytrimethyladipate, and peroxycarbonates such as diisopropyl peroxydicarbonate, di-sec-butyl peroxydicarbonate and tert-butyl peroxyisopropylcarbonate.

The macromolecular compound to be used for the present invention preferably has a weight average molecular weight of 3000 to 1000000, more preferably 5000 to 500000 and it may be in a linear form, a branched form, or a cyclic form.

The molar amount to be charged of the polymerizable monomer that has an active hydrogen-containing group and serves as a raw material of the repeating unit represented by formula (1) and formula (2) to be used for the present invention is preferably from 1 mol % to 95 mol %, more preferably from 5 mol % to 80 mol %, and even more preferably from 10 mol % to 70 mol % based on the sum total of all monomers to be used for the polymerization. When the molar amount to be charged of the polymerizable monomer that has an active hydrogen-containing group and serves as a raw material of the repeating unit represented by formula (1) and formula (2) is less than 1 mol %, sufficient solvent resistance may not be obtained, and when it is larger than 95 mol %, storage stability may become poor.

Examples of the macromolecular compound to be used for the present invention include poly{styrene-co-pentafluorostyrene-co-[4-[(2′-methacryloyloxyethyl)aminocarbonylamino]-styrene]},
poly{styrene-co-pentafluorostyrene-co-acrylonitrile-co-[4-[(2′-methacryloyloxyethyl)aminocarbonylamino]-styrene]}, poly{vinyl
benzoate-co-pentafluorostyrene-co-[4-[(2′-methacryloyloxyethyl)aminocarbonylamino]-styrene]}, poly{vinyl
benzoate-co-pentafluorostyrene-co-acrylonitrile-co-[4-[(2′-methacryloyloxyethyl)aminocarbonylamino]-styrene]}, poly{styrene-co-pentafluorostyrene-co-methyl
methacrylate-co-[4-[(2′-methacryloyloxyethyl)aminocarbonylamino]-styrene]},
poly{styrene-co-pentafluorostyrene-co-[4-[(2′-methacryloyloxyethyl)aminocarbonyloxy]-styrene]},
poly{styrene-co-pentafluorostyrene-co-acrylonitrile-co-[4-[(2′-methacryloyloxyethyl)aminocarbonyloxy]-styrene]}, poly{vinyl
benzoate-co-pentafluorostyrene-co-[4-[(2′-methacryloyloxyethyl)aminocarbonyloxy]-styrene]}, poly{vinyl
benzoate-co-pentafluorostyrene-co-acrylonitrile-co-[4-[(2′-methacryloyloxyethyl)aminocarbonyloxy]-styrene]} and poly{styrene-co-pentafluorostyrene-co-methyl
methacrylate-co-[4-[(2′-methacryloyloxyethyl)aminocarbonyloxy]-styrene]}.

Curing Agent (B)

The curing agent (B) to be used for the present invention includes organic azo compounds and organic peroxides.

Examples of the organic diazo compounds include 2,2′-azobisisobutyronitrile, 2,2′-azobisisovaleronitrile, 2,2′-azobis(2,4-dimethylvaleronitrile), 4,4′-azobis(4-cyanovaleric acid), 1,1′-azobis(cyclohexanecarbonitrile), 2,2′-azobis (2-methylpropane) and 2,2′-azobis(2-methylpropionamidine) dihydrochloride and azobisisobutyronitrile.

Examples of the organic peroxides include ketone peroxides such as methyl ethyl ketone peroxide, methyl isobutyl ketone peroxide, cyclohexanone peroxide and acetylacetone peroxide, diacyl peroxides such as isobutyl peroxide, benzoyl peroxide, 2,4-dichlorobenzoyl peroxide, o-methylbenzoyl peroxide, lauroyl peroxide and p-chlorobenzoyl peroxide, hydroperoxides such as 2,4,4-trimethylpentyl-2-hydroperoxide, diisopropylbenzene peroxide, cumene hydroperoxide and tert-butyl peroxide, dialkyl peroxides such as dicumyl peroxide, tert-butylcumyl peroxide, di-tert-butyl peroxide and tris(tert-butyl peroxide)triazine, peroxyketals such as 1,1-di-tert-butylperoxycyclohexane and 2,2-di(tert-butyl peroxide)butane, alkyl peresters such as tert-butyl peroxyperpivalate, tert-butyl peroxy-2-ethylhexanoate, tert-butyl peroxyisobutylate, di-tert-butyl peroxyhexahydroterephthalate, di-tert-butyl peroxyazelate, tert-butyl peroxy-3,5,5-trimethylhaxonoate, tert-butyl peroxyacetate, tert-butyl peroxybenzoate and di-tert-butyl peroxytrimethyladipate, and peroxycarbonates such as diisopropyl peroxydicarbonate, di-sec-butyl peroxydicarbonate, tert-amyl peroxyisopropylcarbonate and tert-butyl peroxyisopropylcarbonate.

The curing agent to be used for the present invention preferably has a 10-hour half-life temperature of 30° C. to 200° C., more preferably a 10-hour half-life temperatures of 40° C. to 150° C., and even more preferably a 10-hour half-life temperatures of 40° C. to 100° C.

When the 10-hour half-life temperature is lower than 30° C., storage stability may become poor, and gelation may occur, and when it is higher than 200° C., adverse influence may be exerted on an organic semiconductor compound at the time of curing.

Organic Solvent (C)

The organic solvent to be used for the present invention has no particular limitation as far as it is a good solvent for the aforementioned macromolecular compound (A) comprising at least one kind of repeating unit selected from the group consisting of repeating units represented by formula (1) and repeating units represented by formula (2), and for the curing agent (B), and it is a poor solvent for an organic semiconductor compound. Examples thereof include butyl acetate, 2-heptanone and propylene glycol monomethyl ether acetate.

In the resin composition for an organic thin film transistor insulating layer of the present invention, the weight of the organic solvent is preferably 50 to 1000 parts by weight when the total of the weight of the macromolecular compound comprising at least one kind of repeating unit selected from the group consisting of repeating units represented by formula (1) and repeating units represented by formula (2), and the weight of the curing agent is 100 parts by weight.

The weight of the curing agent is preferably 0.1 to 10 parts by weight when the part by weight of the macromolecular compound comprising at least one kind of repeating unit selected from the group consisting of repeating units represented by formula (1) and repeating units represented by formula (2) is 100 parts by weight.

To the resin composition for an organic thin film transistor insulating layer of the present invention can, if needed, be add a cross-linking agent, a leveling agent, a surfactant, and so on.

Examples of the cross-linking agent include low-molecular compounds having two or more unsaturated double bonds in their molecules and cross-linking agents for acrylic resins.

Examples of the low-molecular compounds having two or more unsaturated double bonds in their molecules include divinylbenzene and trimethylolpropane trimethacrylate.

Examples of the cross-linking agents for acrylic resins include dicumyl peroxide and 4,4-di-tert-butylperoxy-n-butyl valerate.

Organic Thin Film Transistor

FIG. 1 is a schematic cross-sectional view illustrating the structure of a bottom gate type organic thin film transistor which is one embodiment of the present invention. This organic thin film transistor has a substrate 1, a gate electrode 2 formed on the substrate 1, a gate insulating layer 3 formed on the gate electrode 2, an organic semiconductor layer 4 formed on the gate insulating layer 3, a source electrode 5 and a drain electrode 6 formed across a channel portion on the organic semiconductor layer 4, and an overcoat 7 covering the whole body of the device.

One embodiment of the method for producing the above-described organic thin film transistor comprises (i) a step of forming a gate electrode on a substrate, (ii) a step of forming a gate insulating layer on the gate electrode, (iii) a step of forming an organic semiconductor layer on the gate insulating layer, (iv) a step of forming a source electrode and a drain electrode on the organic semiconductor layer, and (v) a step of forming an overcoat layer so that the device may be wholly covered. At least one of the gate insulating layer to be formed in step (ii) and the overcoat layer to be formed in step (v) is formed by applying, drying and curing a resin solution which contains the resin composition for an organic thin film transistor insulating layer of the present invention.

Examples of the material of the gate electrode to be formed in step (1) include chromium, gold, silver and aluminum. The gate electrode can be formed by such a conventional method as a vacuum deposition process, a sputtering process, a printing process and an ink-jet process.

When a resin solution which contains the resin composition for an organic thin film transistor insulating layer of the present invention is used as a gate insulating layer is formed in step (ii), the organic solvent contained in the resin solution is not particularly restricted as far as it can dissolve the resin composition to be used, and it is preferably the one which has a boiling point under ordinary pressure of 100° C. to 200° C. Examples of the organic solvent include 2-heptanone and propylene glycol monomethyl ether acetate.

To the resin solution can, if needed, be added a leveling agent, a curing catalyst and so on. The gate insulating layer application liquid can be applied onto the gate electrode by conventional spin coating, a die coater, screen printing, ink-jet or the like.

On the gate insulating layer may also be formed a self-assembled monomolecular film layer. The self-assembled monomolecular film layer can be formed by, for example, treating the gate insulating layer with a solution in which 1 to 10% by weight of an alkylchlorosilane compound or an alkylalkoxysilane compound has been dissolved in an organic solvent.

Examples of the alkylchlorosilane compound include methyltrichlorosilane, ethyltrichlorosilane, butyltrichlorosilane, decyltrichlorosilane and octadecyltrichlorosilane.

Examples of the alkylalkoxysilane compound include methyltrimetoxysilane, ethyltrimethoxysilane, butyltrimethoxysilane, decyltrimetoxysilane and octadecyltrimethoxysilane.

Formation of the organic semiconductor layer in step (iii) is performed usually by applying and drying an organic semiconductor coating solution prepared by dissolving an organic semiconductor compound in an organic solvent. The organic solvent to be used for the organic semiconductor coating solution is not particularly restricted as far as it can dissolve the organic semiconductor compound, and it is preferably the one which has a boiling point under ordinary pressure of 50° C. to 200° C.

Examples of the organic solvent include chloroform, toluene, anisole, 2-heptanone and propylene glycol monomethyl ether acetate. Like the above-mentioned gate insulating layer coating solution, the organic semiconductor coating solution can be applied onto the gate insulating layer by conventional spin coating, a die coater, screen printing, ink-jet or the like.

Examples of the material of the source electrode to be formed and the material of the drain electrode to be formed in step (iv) include chromium, gold, silver and aluminum. The source electrode and the drain electrode can be formed by the same method as that for the above-described gate electrode.

When a resin solution containing the resin composition for an organic thin film transistor insulating layer of the present invention is used as an overcoat layer is formed in step (v), the resin solution can be applied onto the organic semiconductor layer by conventional spin coating, a die coater, screen printing, ink-jet or the like as in the case of forming the aforementioned gate insulating layer. The curing temperature is preferably 50° C. to 250° C., more preferably 60° C. to 230° C., and even more preferably 80° C. to 200° C. The curing time can be chosen appropriately depending on the curing temperature. If the curing temperature is lower than 50° C., curing may become insufficient, whereas if it is higher than 250° C., the macromolecular compound may be thermally decomposed.

For the curing method can be used a conventional hot plate, an oven, a far-infrared baking furnace or the like. The atmosphere, which is not particularly restricted, may be the air or an inert gas atmosphere and preferably is an inert gas atmosphere.

FIG. 2 is a schematic cross-sectional view illustrating the structure of a top gate type organic thin film transistor which is another embodiment of the present invention. This organic thin film transistor has a substrate 1, a source electrode 5 and a drain electrode 6 formed on the substrate 1, an organic semiconductor layer 4 formed with a channel part sandwiched on those electrodes, a gate insulating layer 3 that has been formed on the organic semiconductor layer 4 and wholly covers the device, and a gate electrode 2 formed on the surface of the gate insulating layer 3.

One embodiment of the method for producing the above-mentioned organic thin film transistor comprises (a) a step of forming the source electrode and the drain electrode on the substrate, (b) a step of forming the organic semiconductor layer on the source electrode and the drain electrode, (c) a step of forming the gate insulating layer on the organic semiconductor layer, and (d) a step of forming the gate electrode on the gate insulating layer. The gate insulating layer to be formed in step (d) is formed by applying, drying, and curing a resin solution containing the resin composition for an organic thin film transistor insulating layer of the present invention.

Examples of the material of a source electrode, the method for forming a source electrode, the material of a drain electrode, the method for forming a drain electrode, the material of a gate electrode, the method for forming a gate electrode, the organic solvent to be used for an organic semiconductor coating solution, the method for forming an organic semiconductor layer, the method for applying an insulating layer coating solution containing a resin composition for an organic thin film transistor insulating layer, the temperature, the time and the method for curing the insulating layer coating solution are the same materials and methods as those described before.

On the insulating layer produced using the resin composition for an organic thin film transistor insulating layer of the present invention, a flat layer and the like can be formed, and thereby it is possible to form a layered structure easily. Moreover, an organic electroluminescent device can be suitably mounted on the insulating layer.

By the use of the organic thin film transistor of the present invention, a member for displays that has an organic thin film transistor can suitably be produced. By the use of the member for displays that has an organic thin film transistor, a display that has a member for displays can suitably be produced.

### EXAMPLES

The present invention is described below in more detail by way of Examples, but it is needless to say that the invention is not limited by the Examples.

### Synthesis Example 1

Into a 125-ml pressure-resistant container (manufactured by ACE) were charged 8.47 g of vinyl benzoate (produced by Aldrich), 6.16 g of 2-trifluoromethylstyrene (produced by Aldrich), 6.16 g of 4-trifluoromethylstyrene (produced by Aldrich), 1.70 g of 4-aminostyrene (produced by Aldrich), 0.22 g of 2,2′-azobis(isobutyronitrile) and 52.93 g of 2-heptanone (produced by Wako Pure Chemical Industries, Ltd.), followed by bubbling with nitrogen. Then, the container was stopped tightly, followed by polymerization performed in an oil bath at 60° C. for 48 hours, so that a viscous solution was obtained.

To the resulting viscous solution was added 2.21 g of 2-methacryloyloxyethyl isocyanate (Karenz MOI, produced by Showa Denko K.K.), followed by a reaction performed at room temperature for 24 hours, so that a 2-heptanone solution of macromolecular compound 1 was obtained.

Macromolecular compound 1 has repeating units represented by formula (A) through formula (D).

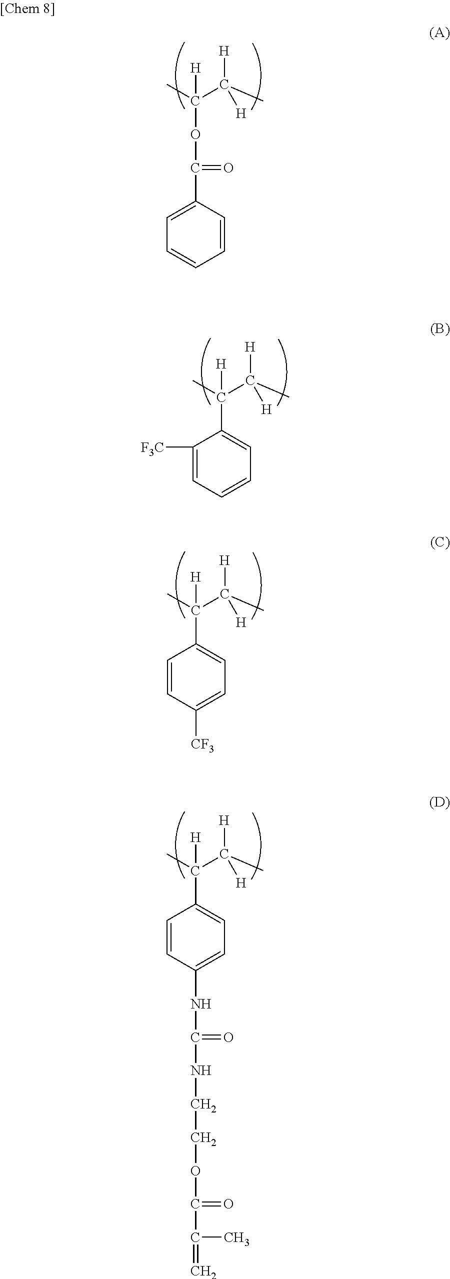

The weight average molecular weight determined using standard polystyrenes of the obtained macromolecular compound 1 was 19000. (GPC manufactured by Shimadzu, one Tskgel super HM-H 1 and one Tskgel super H2000, mobile phase=THF)

### Example 1

(Preparation of a Resin Composition for an Organic Thin Film Transistor Insulating Layer)

Into a 10-ml sample tube were charged 3.00 g of a 2-heptanone solution of macromolecular compound 1 and 0.036 g of tert-amyl peroxyisopropyl carbonate (AIC-75, produced by Kayaku Akzo Corporation), which were stirred to dissolve, so that a homogeneous coating solution was prepared.

The resulting coating solution was filtered through a membrane filter with a pore size of 0.2 μm, so that a coating solution of macromolecular compound 1 was prepared.

(Production of an Electric Field Effect Type Organic Thin Film Transistor)

F8T2 (a copolymer of 9,9-dioctylfluorene:bithiophene=50;50 (molar ratio); polystyrene-equivalent weight average molecular weight=69,000) was dissolved in chloroform, a solvent, to prepare a solution having a concentration of 0.5% by weight (organic semiconductor composition), which was then filtered through a membrane filter, so that an organic semiconductor coating liquid was prepared.

A source electrode and a drain electrode (each having a layered structure composed of chromium and gold in order when viewed from an insulating layer) each having a channel length of 20 μm and a channel width of 2 mm were formed by vacuum vapor deposition using a metal mask, on an n-type crystal silicon substrate, which was a gate electrode having a thermally oxidized film of SiO₂ in a thickness of 300 nm (produced by Advantech Co., Ltd., specific resistance<0.1Ω). Subsequently, the organic semiconductor coating solution was applied by spin coating method onto the substrate with the electrodes, followed by baking at 100° C. for 10 minutes, so that an active layer having a thickness of about 60 nm was formed and thereby a bottom-gate/bottom-contact type transistor was produced.

Next, a coating solution of macromolecular compound 1 was spin coated onto the resulting transistor and then was baked at 200° C. for 1 minute on a hot plate in nitrogen atmosphere, so that an electric field effect type organic thin film transistor with a 500 nm thick overcoat layer was produced.

<Transistor Characteristics of an Electric Field Effect Type Organic Thin Film Transistor>

For the thus-produced electric field effect type organic thin film transistor, Von voltage, ON/OFF ratio and on-current density at −60 V (Ion, A/cm²), the transistor characteristics thereof, were measured by using a vacuum prober (BCT22MDC-5-HT-SCU; manufactured by Nagase Electronic Equipments Service Co., Ltd.) under such conditions that a gate voltage Vg was varied from 10 to −60 V and a source-drain voltage Vsd was varied from 0 to −60 V. The results are shown in Table 2.

<Electrical Characteristics of an Insulating Layer>

A coating solution of macromolecular compound 1 was applied onto a silicon substrate, at the back surface of which aluminum had been vapor-deposited, and was baked at 200° C. for 1 minute in nitrogen atmosphere, so that an insulating layer (507 nm in thickness) was formed. Then, an aluminum electrode was vapor-deposited on the insulating layer by using a metal mask, so that a device for evaluation was produced. The electrical properties of the resulting evaluation device were measured using a vacuum prober (BCT22MDC-5-HT-SCU; manufactured by Nagase Electronic Equipments Service Co., Ltd.). The results are shown in Table 1.

TABLE 1

| Electrical characteristics | Measured value |
|---|---|
| Leak current density at 1 MV (A/cm²) | 5.4 × 10⁻¹¹ |
| Dielectric breakdown voltage | >2 MV |
| Dielectric constant at 100 kHz | 2.75 |

<Adhesion Property of an Insulating Layer>

A coating solution of macromolecular compound 1 was applied onto a silicon substrate and was baked at 200° C. for 1 minute in nitrogen atmosphere, so that an insulating layer (507 nm in thickness) was formed. Then, an aluminum electrode was vapor-deposited on the insulating layer by using a metal mask. When a Kapton tape was adhered on the aluminum electrode and then the Kapton tape was removed, no peeling was caused in the aluminum electrode.

### Comparative Example 1

(Production of an Electric Field Effect Type Organic Thin Film Transistor)

An electric field effect type organic thin film transistor was produced in the same manner as in Example 1 except that no coating solution of macromolecular compound 1 was applied, and then, Von voltage, ON/OFF ratio and on-current density on −60 V (Ion, A/cm²), the transistor characteristics of the electric field effect type organic thin film transistor, were measured. The results are shown in Table 2.

### Evaluation Example 1

<Adhesion Property of a Fluororesin>

Cytop (produced by Asahi Glass Co., Ltd.), a fluororesin, was applied onto a silicon substrate and was baked at 200° C. for 10 minutes in nitrogen atmosphere, so that an insulating layer (1 μm in thickness) was formed. Then, an aluminum electrode was vapor-deposited on the insulating layer by using a metal mask. When a Kapton tape was adhered on the aluminum electrode and then the Kapton tape was removed, the aluminum electrode was peeled off.

TABLE 2

| | Example 1 | Comparative Example 1 |
|---|---|---|
| Von Voltage (V) | 0 | −21 |
| ON/OFF ratio | 10⁵ | 10⁶ |
| Ion at −60 V (A/cm²) | 1 × 10⁻⁵ | 1 × 10⁻⁵ |

### EXPLANATION OF NUMBERING

1—Substrate,

2—gate electrode,

3—gate insulating layer,

4—organic semiconductor layer,

5—source electrode,

6—drain electrode.

1. A resin composition for an organic thin film transistor insulating layer characterized by comprising (A) a macromolecular compound comprising a repeating unit having a photosensitive group linked through a urea bond or a urethane bond, (B) a curing agent and (C) an organic solvent.

2. The resin composition for an organic thin film transistor insulating layer according to claim 1, characterized by that the macromolecular compound comprising a repeating unit having a photosensitive group linked through a urea bond or a urethane bond is a macromolecular compound comprising at least one kind of repeating unit selected from the group consisting of repeating units represented by formula (1) and repeating units represented by formula (2): 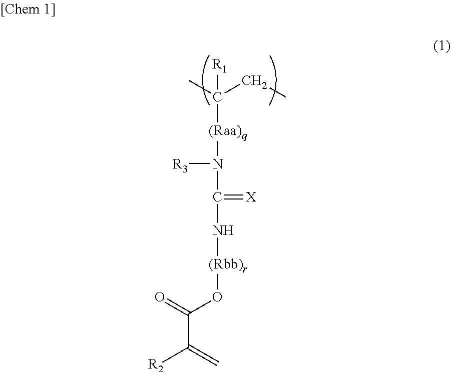
wherein R₁ and R₂, which are the same or different, each represents a hydrogen atom or a methyl group, R₃ represents a hydrogen atom or a monovalent organic group having 1 to 20 carbon atoms, and Raa and Rbb, which are the same or different, each represents a divalent organic group having 1 to 20 carbon atoms; any hydrogen atom in the divalent organic group may be substituted with a fluorine atom; X represents an oxygen atom or a sulfur atom, q represents an integer of 0 to 20, and r represents an integer of 1 to 20; when there are two or more Raa's, they may be the same or different; and when there are two or more Rbb's, they may be the same or different; 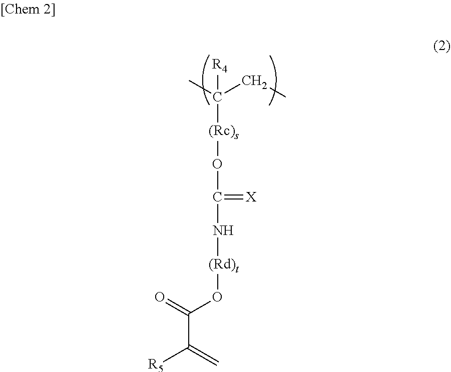
wherein R₄ and R₅, which are the same or different, each represents a hydrogen atom or a methyl group, and Rc and Rd, which are the same or different, each represents a divalent organic group having 1 to 20 carbon atoms; any hydrogen atom in the divalent organic group may be substituted with a fluorine atom; X represents an oxygen atom or a sulfur atom, s represents an integer of 0 to 20, and t represents an integer of 1 to 20; when there are two or more Rc's, they may be the same or different, and when there are two or more Rd's, they may be the same or different.

3. The resin composition for an organic thin film transistor insulating layer according to claim 1, characterized by that the macromolecular compound further comprises at least one kind of repeating unit selected from the group consisting of repeating units represented by formula (3), repeating units represented by formula (4), repeating units represented by formula (5), and repeating units represented by formula (6): 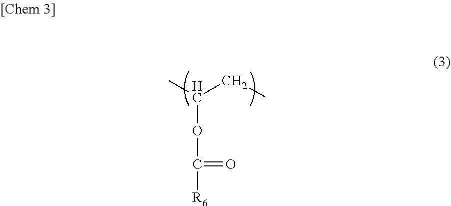
wherein R₆ represents a monovalent organic group having 1 to 20 carbon atoms, and any hydrogen atom in the monovalent organic group may be substituted with a fluorine atom; 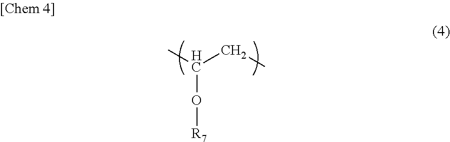
wherein R₇ represents a monovalent organic group having 1 to 20 carbon atoms, and any hydrogen atom in the monovalent organic group may be substituted with a fluorine atom; 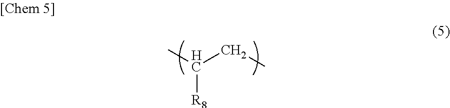
wherein R₈ represents a monovalent organic group having 1 to 20 carbon atoms or a cyano group, and any hydrogen atom in the monovalent organic group may be substituted with a fluorine atom; 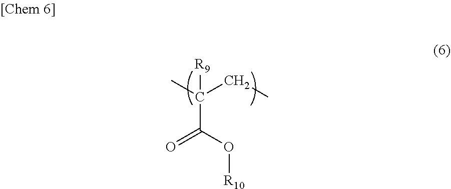
wherein R₉ represents a hydrogen atom or a methyl group, R₁₀ represents a monovalent organic group having 1 to 20 carbon atoms, and any hydrogen atom in the monovalent organic group may be substituted with a fluorine atom.

4. An organic thin film transistor characterized by using the resin composition for an organic thin film transistor insulating layer according to claim 1 as an overcoat layer.

5. An organic thin film transistor characterized by using the resin composition for an organic thin film transistor insulating layer according to claim 1 as a gate insulating layer.

6. A member for a display comprising the resin composition for an organic thin film transistor insulating layer according to claim 1.

7. A display composed of the member for a display according to claim 6.
